(19) United States
(12) Patent Application Publication
(10) Pub. No.: US 2011/0129692 A1
(43) Pub. Date: Jun. 2, 2011

(54) MAGNETIC ALLOY MATERIALS WITH HCP STABILIZED MICROSTRUCTURE, MAGNETIC RECORDING MEDIA COMPRISING SAME, AND FABRICATION METHOD THEREFOR

(75) Inventor: Thomas Patrick Nolan, Fremont, CA (US)

(73) Assignee: Seagate Technologies LLC, Scotts Valley, CA (US)

(21) Appl. No.: 12/880,353

(22) Filed: Sep. 13, 2010

Related U.S. Application Data
(63) Continuation of application No. 10/902,947, filed on Aug. 2, 2004, now abandoned.

(51) Int. Cl. G11B 5/66; H01F 1/00; B05D 5/12

(52) U.S. Cl. 428/831; 252/62.51 R; 252/62.55; 427/132

(57) ABSTRACT

A magnetic recording medium comprises:
(a) a non-magnetic substrate having a surface; and
(b) a stack of thin film layers on the substrate surface, including a layer of a magnetic alloy material with a stabilized hexagonal close-packed (“hcp”) crystal structure, comprising:
   (i) a major amount of a ferromagnetic element with a first hcp crystal structure having a first c/a ratio, where “c” is a lattice parameter of the unique symmetry axis of the hcp structure along which a preferred direction of magnetization lies and “a” is a lattice parameter along a direction perpendicular to the c axis;
   (ii) a minor amount of a non-magnetic element with a face-centered cubic (fcc) crystal structure; and
   (iii) a minor amount of at least one hcp-stabilizing element.

### FIELD OF THE INVENTION

The present invention relates to magnetic alloy materials with hcp stabilized microstructure, magnetic recording media comprising the hcp-stabilized magnetic alloy materials, and to a method for fabricating same. The invention enjoys particular utility in the manufacture of high performance, high signal-to-noise ratio (SNR) magnetic data/information storage and retrieval media, e.g., hard disks.

### BACKGROUND OF THE INVENTION

In fabricating high performance, high signal-to-noise ratio (SNR) magnetic recording media, it is desirable that the magnetic particles or grains be of small, uniform size and exhibit high coercivity (H_{c}), high magnetic anisotropy (Kᵤ), and a uniform, low value of exchange coupling. The low value of exchange coupling is desired in order to minimize highly correlated magnetic switching of the neighboring magnetic particles or grains. Reduction of the amount of exchange coupling decreases the size of the magnetic particle, grain, or switching unit. The cross-track correlation length and media noise are correspondingly reduced. However, smaller magnetic switching units are less resistant to self-demagnetization and thermal decay than larger switching units. The high value of magnetic anisotropy Kᵤ is desirable in order to increase the resistance to thermal decay and to enable achieving higher values of coercivity H_{c} in smaller particles, thereby promoting sharper magnetic transitions.

According to conventional practice, platinum (Pt) is added to cobalt (Co)-based magnetic alloy layers in order to increase Kᵤ and materials such as chromium (Cr), boron (B), and oxides have been added to the Co-based magnetic alloy layers in order to decrease the amount of exchange coupling. The latter materials preferentially form non-ferromagnetic material at the boundaries between neighboring magnetic particles or grains. However, residual amounts of these materials generally remain in the magnetic particles or grains. Disadvantageously, none of the aforementioned alloying elements or materials added to Co-based magnetic alloys exhibit the hexagonal close-packed (hcp) crystal structure of Co, and thus they can destabilize the hcp structure of the Co to the detriment of the magnetic properties of Co-based magnetic layers. When the concentration of the alloying elements and/or materials in the Co-based magnetic layer becomes too large, an increase in the density of stacking faults in the hcp structure is observed, and the resultant structure has a significant face-centered cubic (fcc) structural component. It is understood that a fcc structure has higher symmetry, and much lower magnetic anisotropy Kᵤ, than a hcp structure, and that an increased density of stacking faults generally results in a reduction of Kᵤ.

In view of the foregoing, there exists a clear need for improved magnetic recording media having a stable hcp crystal microstructure, high Kᵤ, low exchange coupling, and lower stacking fault density than in the conventional art, and to a method for fabricating same which avoids or otherwise obviates the above-described disadvantages and drawbacks associated with the conventional methodology.

The present invention, therefore, addresses and solves the above need for improved high performance, high SNR magnetic recording media exhibiting enhanced performance characteristics, while maintaining full compatibility with all aspects of conventional automated manufacturing technology for fabrication of magnetic recording media, e.g., hard disks. Moreover, the inventive methodology can be readily implemented in a cost-effective manner comparable with that of existing manufacturing technologies.

### DISCLOSURE OF THE INVENTION

An advantage of the present invention is improved magnetic alloy materials.

Another advantage of the present invention is improved magnetic alloy materials with high Kᵤ, low exchange coupling, and stabilized hcp crystal structure.

Yet another advantage of the present invention is improved magnetic alloy materials with fewer stacking faults than in conventional Co-based magnetic alloy layers.

Still another advantage of the present invention is improved magnetic recording media comprising improved magnetic alloy materials.

A further advantage of the present invention is improved magnetic recording media with improved magnetic alloy layers providing high Kᵤ, low exchange coupling, and stabilized hcp crystal structure.

A still further advantage of the present invention is improved magnetic recording media with improved magnetic alloy layers with fewer stacking faults than in media with conventional Co-based magnetic alloy layers.

Still another advantage of the present invention is a method of fabricating improved magnetic recording media comprising improved magnetic alloy materials.

An additional advantage of the present invention is a method of fabricating improved magnetic recording media with improved magnetic alloy layers with high Kᵤ, low exchange coupling, and stabilized hcp crystal structure.

Yet another advantage of the present invention is a method of fabricating improved magnetic recording media with improved magnetic alloy layers with fewer stacking faults than in conventional media with Co-based magnetic alloy layers.

Additional advantages and other features of the present invention will be set forth in the description which follows and in part will become apparent to those having ordinary skill in the art upon examination of the following or may be learned from the practice of the present invention. The advantages of the present invention may be realized as particularly pointed out in the appended claims.

According to an aspect of the present invention, the foregoing and other advantages are obtained in part by a magnetic alloy material with a stabilized hexagonal close-packed (“hcp”) crystal structure, comprising:

(a) a major amount of a ferromagnetic element with a first hcp crystal structure having a first c/a ratio, where “c” is a lattice parameter of the unique symmetry axis of the hcp structure along which a preferred direction of magnetization lies and “a” is a lattice parameter along a direction perpendicular to the c axis;

(b) a minor amount of a non-magnetic element with a face-centered cubic (“fcc”) crystal structure; and

(c) a minor amount of at least one hcp-stabilizing element.

According to preferred embodiments of the present invention, the at least one hcp-stabilizing element has solid solubility in the ferromagnetic element; and the at least one hcp-stabilizing element is present in an amount <˜20 at. %.

In accordance with certain preferred embodiments of the present invention, the at least one hcp-stabilizing element is a non-magnetic element with a hcp crystal structure having a second c/a ratio; and the second c/a ratio is less than, substantially similar to, or greater than said first c/a ratio.

Preferred embodiments include those wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is selected from the group consisting of osmium (Os), c/a ratio=1.579; ruthenium (Ru), c/a ratio=1.582; titanium (Ti), c/a ratio=1.588; and beryllium (Be), c/a ratio=1.568, whereby the second c/a ratio is less than 1.623.

Still other preferred embodiments of the invention include those wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is selected from the group consisting of: rhenium (Re), c/a ratio=1.614 and scandium (Sc), c/a ratio=1.633, whereby the second c/a ratio is close to the first c/a ratio and is 1.623±0.01.

Yet further preferred embodiments of the invention include those wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is zinc (Zn), c/a ratio=1.856, whereby the second c/a ratio is greater than 1.623.

According to still other preferred embodiments of the invention, the at least one hcp-stabilizing element increases the allotropic hcp→fcc transition temperature of the ferromagnetic element, the ferromagnetic element is cobalt (Co) and the at least one hcp-stabilizing element is selected from the group consisting of: iridium (Ir), +40°/at. %; rhodium (Rh), +40°/at. %; lithium (Li); osmium (Os); ruthenium (Ru), +38°/at. %; rhenium (Re), +38°/at. %; silicon (Si), +38°/at. %; and germanium (Ge), +22°/at. %.

Another aspect of the present invention is a magnetic recording medium, comprising:

(a) a non-magnetic substrate having a surface; and

(b) a stack of thin film layers on the surface of said substrate, e layer stack including a layer of a magnetic alloy material with a stabilized hexagonal close-packed (“hcp”) crystal structure, comprising:
(i) a major amount of a ferromagnetic element with a first hcp crystal structure having a first c/a ratio, where “c” is a lattice parameter of the unique symmetry axis of the hcp structure along which a preferred direction of magnetization lies and “a” is a lattice parameter along a direction perpendicular to the c axis;
(ii) a minor amount of a non-magnetic element with a face-centered cubic (“fcc”) crystal structure; and
(iii) a minor amount of at least one hcp-stabilizing element.

According to preferred embodiments of the present invention, the at least one hcp-stabilizing element has solid solubility in the ferromagnetic element; and the at least one hcp-stabilizing element is present in an amount <˜20 at. %.

In accordance with certain preferred embodiments of the invention, the at least one hcp-stabilizing element is a non-magnetic element with a hcp crystal structure having a second c/a ratio; and the second c/a ratio is less than, substantially similar to, or greater than the first c/a ratio.

Preferred embodiments of the invention include those wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is selected from the group consisting of: osmium (Os), c/a ratio=1.579; ruthenium (Ru), c/a ratio=1.582; titanium (Ti), c/a ratio=1.588; and beryllium (Be), c/a ratio=1.568, whereby the second c/a ratio is less than 1.623.

Other preferred embodiments of the invention include those wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is selected from the group consisting of rhenium (Re), c/a ratio=1.614 and scandium (Sc), c/a ratio=1.633, whereby the second c/a ratio is close to the first c/a ratio and is 1.623±0.01.

Still other embodiments of the invention include those wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is zinc (Zn), c/a ratio=1.856, whereby the second c/a ratio is greater than 1.623.

Additional preferred embodiments of the invention include those wherein the at least one hcp-stabilizing element increases the allotropic hcp→fcc transition temperature of the ferromagnetic element; the ferromagnetic element is cobalt (Co) and the at least one hcp-stabilizing element is selected from the group consisting of iridium (Ir), +40°/at. %; rhodium (Rh), +40°/at. %; lithium (Li); osmium (Os); ruthenium (Ru), +38°/at. %; rhenium (Re), +38°/at. %; silicon (Si), +38°/at. %; and germanium (Ge), +22°/at. %.

Still another aspect of the present invention is a method of fabricating a magnetic recording medium including a layer of a magnetic alloy material having a stabilized hexagonal close-packed (“hcp”) crystal structure, comprising sequential steps of:

(a) providing a non-magnetic substrate having a surface; and

(b) forming a stack of thin film layers on the surface of the substrate, the layer stack including a layer of a magnetic alloy material with a stabilized hcp crystal structure, comprising:
(i) a major amount of a ferromagnetic element with a first hcp crystal structure having a first c/a ratio, where “c” is a lattice parameter of the unique symmetry axis of the hcp structure along which a preferred direction of magnetization lies and “a” is a lattice parameter along a direction perpendicular to the c axis;
(ii) a minor amount of a non-magnetic element with a face-centered cubic (“fcc”) crystal structure; and
(iii) a minor amount of at least one hcp-stabilizing element.

According to preferred embodiments of the present invention, step (b) comprises forming a layer wherein the at least one hcp-stabilizing element has solid solubility in the ferromagnetic element; and comprises forming a layer wherein the at least one hcp-stabilizing element is present in an amount <˜20 at. %.

In accordance with certain preferred embodiments of the invention, step (b) comprises forming a layer wherein the at least one hcp-stabilizing element is a non-magnetic element with a hcp crystal structure having a second c/a ratio, and the second c/a ratio is less than, substantially similar to, or greater than the first c/a ratio.

Preferred embodiments of the invention include those wherein step (b) comprises forming a layer wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is selected from the group consisting of: osmium (Os), c/a ratio=1.579; ruthenium (Ru), c/a ratio=1.582; titanium (Ti), c/a ratio=1.588; and beryllium (Be), c/a ratio=1.568, whereby the second c/a ratio is less than 1.623.

Other preferred embodiments of the invention include those wherein step (b) comprises forming a layer wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is selected from the group consisting of: rhenium (Re), c/a ratio=1.614 and scandium (Sc), c/a ratio=1.633, whereby the second c/a ratio is close to the first c/a ratio and is 1.623±0.01.

Still other preferred embodiments of the invention include those wherein step (b) comprises forming a layer wherein the ferromagnetic element with the first hcp crystal structure is cobalt (Co) and the first c/a ratio is 1.623, the non-magnetic element with the fcc crystal structure is platinum (Pt), and the at least one non-magnetic, hcp-stabilizing element is zinc (Zn), c/a ratio=1.856, whereby the second c/a ratio is greater than 1.623.

Additional preferred embodiments of the invention include those wherein step (b) comprises forming a layer wherein the at least one hcp-stabilizing element increases the allotropic hcp→fcc transition temperature of the ferromagnetic element, e.g., step (b) comprises forming a layer wherein the ferromagnetic element is cobalt (Co) and the at least one hcp-stabilizing element is selected from the group consisting of: iridium (Ir), +40°/at. %; rhodium (Rh), +40°/at. %; lithium (Li); osmium (Os); ruthenium (Ru), +38°/at. %; rhenium (Re), +38°/at. %; silicon (Si), +38°/at. %; and germanium (Ge), +22°/at. %.

Preferably, step (b) comprises forming at least the layer by sputter deposition.

A still further aspect of the present invention is an improved magnetic recording medium, comprising:

(a) a non-magnetic substrate having a surface; and

(b) a stack of thin film layers on the surface of the substrate, the layer stack including a layer of a magnetic alloy material with a stabilized hexagonal close-packed (“hcp”) crystal structure, comprising:
(i) a major amount of a ferromagnetic element with a hcp crystal structure;
(ii) a minor amount of a non-magnetic element with a face-centered cubic (“fcc”) crystal structure; and
(iii) a minor amount of at least one hcp-stabilizing element which increases the allotropic hcp→fcc transition temperature of the ferromagnetic element.

According to preferred embodiments of the present invention, the at least one hcp-stabilizing element has solid solubility in the ferromagnetic element and is present in an amount <˜20 at. %; the ferromagnetic element is cobalt (Co); the non-magnetic element with fcc crystal structure is platinum (Pt); and the at least one hcp-stabilizing element is selected from the group consisting of: iridium (Ir), +40°/at. %; rhodium (Rh), +40°/at. %; lithium (Li); osmium (Os); ruthenium (Ru), +38°/at. %; rhenium (Re), +38°/at. %; silicon (Si), +38°/at. %; and germanium (Ge), +22°/at. %.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWING

The following detailed description of the embodiments of the present invention can best be understood when read in conjunction with the following drawing, in which the various features are not necessarily drawn to scale but rather are drawn as to best illustrate the pertinent features, wherein:

FIG. 1 schematically illustrates, in simplified cross-sectional view, a portion of a magnetic recording medium with an hcp stabilized magnetic layer according to the present invention.

### DESCRIPTION OF THE INVENTION

The present invention is based upon recognition that the above-described disadvantages, drawbacks, and problems associated with conventional methodology and technology for fabrication of high performance, high SNR, magnetic recording media such as Co-based media, including longitudinal, perpendicular, and tilted media types, may be eliminated, or at least substantially mitigated, by forming the media as to include at least one layer of a magnetic material having a high value of Kᵤ, low exchange coupling between neighboring magnetic particles or grains, and a stabilized hcp crystal structure.

More specifically, hcp stabilized magnetic materials according to the invention, and high performance, high SNR magnetic recording media, comprise a major amount of a ferromagnetic element with a first hcp crystal structure having a first c/a ratio, where “c” is a lattice parameter of the unique symmetry axis of the hcp structure along which a preferred direction of magnetization lies and “a” is a lattice parameter along a direction perpendicular to the c axis; a minor amount of a non-magnetic element with a face-centered cubic (fcc) crystal structure; and a minor amount of at least one hcp-stabilizing element. Magnetic media according to the invention exhibit increased Kᵤ with improved grain-to-grain uniformity of the magnetic anisotropy.

Typical hcp stabilized magnetic materials of the invention comprise a major amount of hcp cobalt (Co) with a c/a ratio of 1.623, a minor amount of fcc platinum (Pt), and at least one other element that stabilizes the hcp structure. While the hcp stabilizing element(s) generally has (have) an hcp structure and a c-axis lattice parameter to a-axis lattice parameter (c/a) ratio less than the 1.623 c/a ratio of Co, usable hcp stabilizing elements according to the invention may have c/a ratios close to or greater than that of Co. Co—Pt containing magnetic alloys according to the invention have fewer stacking faults than otherwise similar Co—Pt containing alloys according to the conventional art.

As indicated supra, hcp stabilized magnetic alloy materials and layers according to the invention typically comprise at least one hcp-structured alloying element having a lower c/a ratio than that of the major (i.e., host) ferromagnetic element of the alloy, where “c” is the lattice parameter of the unique symmetry axis of the hcp structure along which the preferred magnetization direction lies, and “a” is a lattice parameter along a direction perpendicular to the c-axis.

According to the invention, addition of (an) hcp-structured element(s) having a c/a ratio lower than that of the host ferromagnetic element stabilizes the hcp structure of the alloy with respect to a transition to an fcc structure by motion of stacking faults. For an ideal hcp structure having a c/a ratio of 1.633, addition of a stacking fault to the structure forms a region of nearly perfect fcc-structured material. The excess energy required to form the stacking fault is correspondingly small. For a non-ideal hcp structure with c/a ratio significantly greater or less than 1.633, the simple atomic translations of the stacking fault produce an asymmetric crystal structure with unequal bond lengths and a higher energy than in the ideal case. This structure thus has a much higher stacking fault energy and a stronger driving force to form the hcp structure and is more stable in the hcp form.

Elemental Co has a c/a ratio of 1.623, significantly less than the ideal value of 1.633. Pure Co thus has a significant stacking fault energy and a stable hcp structure wherein few stacking faults are observed, as for example, by high-resolution transmission electron microscopy (TEM) or transmission electron diffraction of sputtered Co films.

However, as Pt is alloyed with Co (e.g., to form Co—Pt magnetic alloy materials for use in magnetic recording media), the c/a ratio is observed to increase toward the ideal ratio. The Co—Pt alloy stacking fault energy is correspondingly decreased, and the Co—Pt alloys are observed to have much higher concentrations of stacking faults than pure (i.e., elemental) Co.

At the same time, alloying of Pt with Co results in a rapid increase in Kᵤ with Pt addition, up to about 15 at. % Pt. In the range from about 15 at. % Pt to about 25 at. % Pt, the rate of increase in Kᵤ decreases, as the increase in Kᵤ from the Pt addition is counterbalanced by the decrease in Kᵤ due to the increasing fcc content of the material. In this regard, a maximum has been reported at 19 at. % Pt. Along with a decreased average Kᵤ, the stacking faults also increase the grain-to-grain variation of Kᵤ, since some grains will have more stacking faults than others.

A number of metallic elements besides Co have hcp crystal structures, each with different lattice parameters and c/a ratios varying from 1.568 for beryllium (Be) to 1.886 for cadmium (Cd). Several of these hcp-structured metals have lattice parameters sufficiently close to those of Co as to have significant solid solubility therein. According to the invention, the hcp-structured phase of Co—Pt containing magnetic alloys is stabilized by addition of at least one such solid-soluble hcp-structured element.

Preferred, but non-limitative, embodiments of the invention are described below. In each case, the amount of the at least one hcp-stabilizing element is less than about 20 at. % in order to maintain sufficient Mₛ of the alloy.

A first group of preferred embodiments of the invention include those wherein the ferromagnetic element of the alloy is Co with a hcp crystal structure and c/a ratio of 1.623, the non-magnetic element with the fcc crystal structure is platinum (Pt), and the at least one non-magnetic, hcp-stabilizing element is selected from the group consisting of: osmium (Os), c/a ratio=1.579; ruthenium (Ru), c/a ratio=1.582; titanium (Ti), c/a ratio=1.588; and beryllium (Be), c/a ratio=1.568, whereby the c/a ratio is less than that of Co. Addition of the at least one hcp-stabilizing element increases the hcp→fcc transition temperature relative to that of pure (elemental) Co.

Another group of preferred embodiments of the invention include those wherein the ferromagnetic element of the alloy again is Co with a hcp crystal structure and c/a ratio of 1.623, the non-magnetic element with the fcc crystal structure again is platinum (Pt), and the at least one non-magnetic, hcp-stabilizing element is selected from the group consisting of rhenium (Re), c/a ratio=1.614 and scandium (Sc), c/a ratio=1.633, whereby the c/a ratio is close to that of pure Co and is 1.623±0.01.

A still further group of preferred embodiments of the invention include those wherein the ferromagnetic element of the alloy again is Co with a hcp crystal structure and c/a ratio of 1.623, the non-magnetic element with the fcc crystal structure again is platinum (Pt), and the at least one non-magnetic, hcp-stabilizing element is zinc (Zn), c/a ratio=1.856, whereby the c/a ratio is greater than 1.623, e.g., greater than 1.633.

Yet another group of preferred embodiments of the invention include those wherein the at least one hcp-stabilizing element increases the allotropic hcp→fcc transition temperature of the ferromagnetic element; the ferromagnetic element is cobalt (Co) and the at least one hcp-stabilizing element is selected from the group consisting of: iridium (Ir), +40°/at. %; rhodium (Rh), +40°/at. %; lithium (Li); osmium (Os); ruthenium (Ru), +38°/at. %; rhenium (Re), +38°/at. %; silicon (Si), +38°/at. %; and germanium (Ge), +22°/at. %.

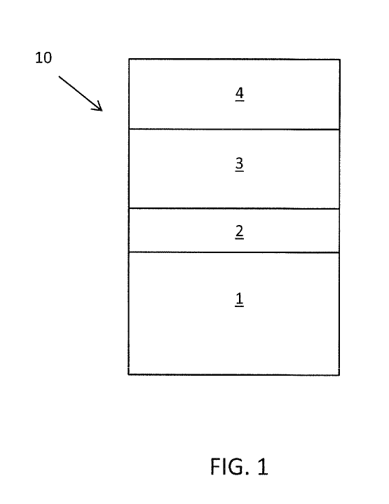

Referring to FIG. 1, schematically illustrated therein, in simplified cross-sectional view, is a portion of a magnetic recording medium 10 with an hcp-stabilized magnetic layer according to the present invention, wherein reference numeral 1 indicates a non-magnetic substrate and reference numerals 2, 3, and 4 indicate a stack of thin film layers respectively including an underlayer structure, at least one hcp-stabilized magnetic layer, and a protective overcoat layer.

According to the invention, each of the thin film layers 2, 3, and 4 may be formed in conventional manner, typically by means of sputter deposition. Substrate 1 is comprised of a conventionally employed non-magnetic metal, alloy, glass, polymer, or composite material; underlayer structure 2 is comprised of several layers; depending upon the media type, e.g., longitudinal, perpendicular, tilted, etc., and may include adhesion layers, seed layers, crystal growth and orienting underlayer(s), intermediate layers, and soft magnetic underlayers of appropriately selected respective thicknesses; the at least one hcp-stabilized magnetic layer 3 is similarly of appropriate thickness for the particular media type, e.g., ˜5-˜50 nm for longitudinal and perpendicular media; and protective overcoat layer 4 typically comprises a diamond-like carbon (DLC) layer of appropriate thickness for a selected application.

Advantages afforded by the hcp-stabilized magnetic alloy structure of the invention include:

1. lower stacking fault density than for conventional magnetic media with Co—Pt alloys having similar at. % Pt;

2. Kᵤ values of the inventive magnetic recording media which reduce with M₃ more slowly than in conventional magnetic media with Co—Pt alloys having similar at. % Pt; and

3. Mₛ of the inventive magnetic recording media can be reduced with smaller reduction of Kᵤ than in conventional media upon addition of bcc chromium (Cr).

In the previous description, numerous specific details are set forth, such as specific materials, structures, processes, etc., in order to provide a better understanding of the present invention. However, the present invention can be practiced without resorting to the details specifically set forth herein. In other instances, well-known processing techniques and structures have not been described in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

1.-34. (canceled)

35. A magnetic alloy material comprising:
a ferromagnetic element with a first hcp crystal structure having a first c/a ratio, where “c” is a lattice parameter of the unique symmetry axis of the hcp structure along which a preferred direction of magnetization lies and “a” is a lattice parameter along a direction perpendicular to the c axis;
a non-magnetic element with a face-centered cubic (“fcc”) crystal structure; and
at least one hcp-stabilizing element.

36. The material as in claim 35, wherein said at least one hcp-stabilizing element has solid solubility in said ferromagnetic element.

37. The material as in claim 36, wherein said at least one hcp-stabilizing element is a non-magnetic element with a hcp crystal structure having a second c/a ratio that is less than said first c/a ratio and said magnetic alloy material has a c/a ratio less than 1.633.

38. The material as in claim 37, wherein said ferromagnetic element with said first hcp crystal structure is cobalt (Co) and said first c/a ratio is 1.623, said non-magnetic element with said fcc crystal structure is platinum (Pt), and said at least one non-magnetic, hcp-stabilizing element is selected from the group consisting of: osmium (Os), c/a ratio=1.579; ruthenium (Ru), c/a ratio=1.582; titanium (Ti), c/a ratio=1.588; beryllium (Be), c/a ratio=1.568; and rhenium (Re), c/a ratio=1.614 whereby said second c/a ratio is less than 1.623.

39. The material as in claim 36, wherein said at least one hcp-stabilizing element increases the allotropic hcp-to-fcc transition temperature of said ferromagnetic element.

40. The material as in claim 39, wherein: said ferromagnetic element is cobalt (Co), said non-magnetic element with said fcc crystal structure is platinum (Pt), and said at least one hcp-stabilizing element raises the hcp to fcc allotropic phase transition temperature of the Co-alloy, selected from the group consisting of: iridium (Ir), +40°/at %; rhodium (Rh), +40°/at %; lithium (Li); osmium (Os); ruthenium (Ru), +38°/at %; rhenium (Re), +38°/at %; silicon (Si), +38°/at %; and germanium (Ge), +22°/at %.

41. The material as in claim 36, wherein said ferromagnetic element with said first hcp crystal structure is cobalt (Co) and first c/a ratio is 1.623, said non-magnetic element with said fcc crystal structure is platinum (Pt), and said at least one non-magnetic, hcp-stabilizing element is zinc (Zn), c/a ratio=1.856, whereby said second c/a ratio is greater than 1.623 and said material has a c/a ratio greater than 1.633.

42. The material as in claim 36, wherein: said fcc material comprises >about 15 at % Platinum (Pt).

43. The material as in claim 42, wherein: said at least one hcp-stabilizing element is present in an amount <about 15 at %.

44. The material as in claim 43, wherein: said fcc material comprises 18-25 at % Pt and said at least one hcp-stabilizing element is present in an amount between 3-10 at %.

45. A magnetic recording medium, comprising:
a non-magnetic substrate having a surface; and
a stack of thin film layers on said surface of said substrate, said layer stack including a layer of a magnetic alloy material with a stabilized hexagonal close-packed (“hcp”) crystal structure, comprising:
cobalt (Co) with a first hcp crystal structure having a first c/a ratio of about 1.623, where “c” is a lattice parameter of the unique symmetry axis of the hcp structure along which a preferred direction of magnetization lies and “a” is a lattice parameter along a direction perpendicular to the c axis;
Platinum (Pt) with a face-centered cubic (“fcc”) crystal structure; and
at least one hcp-stabilizing element.

46. The medium as in claim 45, wherein said Pt comprises at least 15 at % of said alloy and said at least one hcp-stabilizing element has solid solubility in Co and comprises less than 15 at % of said alloy.

47. The medium as in claim 46, wherein: said at least one hcp-stabilizing element has an hcp crystal structure having a second c/a ratio and is selected from the group consisting of: osmium (Os), c/a ratio=1.579; ruthenium (Ru), c/a ratio=1.582; titanium (Ti), c/a ratio=1.588; and beryllium (Be), c/a ratio=1.568, whereby said second c/a ratio is significantly less than 1.623 and said layer of a magnetic alloy material has a c/a ratio less than 1.633.

48. The medium as in claim 46, wherein said at least one hcp-stabilizing element increases the allotropic hcp-to-fcc transition temperature of Co, and is selected from the group consisting of: iridium (Ir), +40°/at %; rhodium (Rh), +40°/at %; lithium (Li); osmium (Os); ruthenium (Ru), +38°/at %; rhenium (Re), +38°/at %; silicon (Si), +38°/at %; and germanium (Ge), +22°/at %.

49. A magnetic recording medium, comprising:
a non-magnetic substrate having a surface; and
a stack of thin film layers on said surface of said substrate, said layer stack including a layer of a magnetic alloy material with a stabilized hexagonal close-packed (“hcp”) crystal structure, comprising:
cobalt (Co) with a first hcp crystal structure having a first c/a ratio of about 1.623, where “c” is a lattice parameter of the unique symmetry axis of the hcp structure along which a preferred direction of magnetization lies and “a” is a lattice parameter along a direction perpendicular to the c axis;
Platinum (Pt) with a face-centered cubic (“fcc”) crystal structure; and
at least one hcp-stabilizing element, wherein said at least one hcp-stabilizing element has an hcp crystal structure having a second c/a ratio and is selected from the group consisting of: osmium (Os), c/a ratio=1.579; ruthenium (Ru), c/a ratio=1.582; titanium (Ti), c/a ratio=1.588; beryllium (Be), c/a ratio=1.568; and rhenium (Re), c/a ratio=1.614, whereby said second c/a ratio is less than 1.623 and said layer of a magnetic alloy material has a c/a ratio less than 1.633.

50. A magnetic recording medium, comprising:
a non-magnetic substrate having a surface; and
a stack of thin film layers on said surface of said substrate, said layer stack including a layer of a magnetic alloy material with a stabilized hexagonal close-packed (“hcp”) crystal structure, comprising:
cobalt (Co) with a first hcp crystal structure having a first c/a ratio of about 1.623, where “c” is a lattice parameter of the unique symmetry axis of the hcp structure along which a preferred direction of magnetization lies and “a” is a lattice parameter along a direction perpendicular to the c axis;
Platinum (Pt) with a face-centered cubic (“fee”) crystal structure; and
at least one hcp-stabilizing element, wherein: said at least one hcp-stabilizing element increases the allotropic hcp-to-fcc transition temperature of Co, and is selected from the group consisting of: iridium (Ir), +40°/at %; rhodium (Rh), +40°/at %; lithium (Li); osmium (Os); ruthenium (Ru), +38°/at %; rhenium (Re), +38°/at %; silicon (Si), +38°/at %; and germanium (Ge), +22°/at %.

51. A method of fabricating a magnetic recording medium including a layer of magnetic alloy material with a stabilized hexagonal close-packed (“hcp”) crystal structure, comprising:
providing a non-magnetic substrate having a surface; and
forming a stack of thin film layers on said surface of said substrate, said layer stack including a layer of a magnetic alloy material with a stabilized hexagonal close-packed (“hcp”) crystal structure, comprising:
cobalt (Co) with a first hcp crystal structure having a first c/a ratio of about 1.623, where “c” is a lattice parameter of the unique symmetry axis of the hcp structure along which a preferred direction of magnetization lies and “a” is a lattice parameter along a direction perpendicular to the c axis;
Platinum (Pt) with a face-centered cubic (“fcc”) crystal structure; and
at least one hcp-stabilizing element.

52. The method of claim 51, wherein forming said layer of the magnetic alloy material comprises said at least one hcp-stabilizing element having a solid solubility in said ferromagnetic element.

53. The method of claim 52, wherein said at least one hcp-stabilizing element is a non-magnetic element with a hcp crystal structure having a second c/a ratio that is less than said first c/a ratio and said magnetic alloy material has a c/a ratio less than 1.633.

54. The method of claim 53, further comprising forming said layer of the magnetic alloy wherein said ferromagnetic element with said first hcp crystal structure is cobalt (Co) and said first c/a ratio is 1.623, said non-magnetic element with said fcc crystal structure is platinum (Pt), and said at least one non-magnetic, hcp-stabilizing element is selected from the group consisting of: osmium (Os), c/a ratio-1.579; ruthenium (Ru), c/a ratio=1.582; titanium (Ti), c/a ratio=1.588; beryllium (Be), c/a ratio=1.568; and rhenium (Re), c/a ratio=1.614 whereby said second c/a ratio is less than 1.623.

55. The method of claim 52, further comprising forming said layer of the magnetic alloy wherein said at least one hcp-stabilizing element increases the allotropic hcp-to-fcc transition temperature of said ferromagnetic element.

56. The method of claim 55, further comprising forming said layer of the magnetic alloy, wherein said ferromagnetic element with said first hcp crystal structure is cobalt (Co), said non-magnetic element with said fcc crystal structure is platinum (Pt), and said at least one hcp-stabilizing element raises the hcp to fcc allotropic phase transition temperature of the Co-alloy, selected from the group consisting of: iridium (Ir), +40°/at %; rhodium (Rh), +40°/at %; lithium (Li); osmium (Os); ruthenium (Ru), +38°/at %; rhenium (Re), +38°/at %; silicon (Si), +38°/at %; and germanium (Ge), +22°/at %.

57. The method of claim 52, further comprising forming said layer of the magnetic alloy, wherein said ferromagnetic element with said first hcp crystal structure is cobalt (Co) and first c/a ratio is 1.623, said non-magnetic element with said fcc crystal structure is platinum (Pt), and said at least one non-magnetic, hcp-stabilizing element is zinc (Zn), c/a ratio=1.856, whereby said second c/a ratio is greater than 1.623 and said material has a c/a ratio greater than 1.633.

58. The method of claim 52, further comprising forming said layer of the magnetic alloy, wherein said fcc material comprises more than about 15 at % Platinum (Pt).

59. The method of claim 58, further comprising forming said layer of the magnetic alloy, wherein said at least one hcp-stabilizing element is present in an amount less than about 15 at %.

60. The method of claim 59, further comprising forming said layer of the magnetic alloy, wherein said fcc material comprises 18-25 at % Pt and said at least one hcp-stabilizing element is present in an amount between 3-10 at %.
